(19) United States
(12) Patent Application Publication
(10) Pub. No.: US 2024/0334386 A1
(43) Pub. Date: Oct. 3, 2024

(54) OPERATION METHOD RELATED TO POSITIONING OF SIDELINK REMOTE UE IN WIRELESS COMMUNICATION SYSTEM

(71) Applicant: LG Electronics Inc., Seoul (KR)

(72) Inventors: Seoyoung BACK, Seoul (KR); Giwon PARK, Seoul (KR); Hanbyul SEO, Seoul (KR); Seungmin LEE, Seoul (KR); Jongwoo HONG, Seoul (KR)

(21) Appl. No.: 18/579,246

(22) PCT Filed: Jul. 13, 2022
(86) PCT No.: PCT/KR2022/010195

§ 371 Date: Jan. 12, 2024

(30) Foreign Application Priority Data
Jul. 13, 2021 (KR) 10-2021-0091738

(51) Int. Cl. H04W 64/00; H04L 5/00; H04W 92/18

(52) U.S. Cl. CPC H04W 64/006; H04L 5/0048; H04W 92/18

(57) ABSTRACT

According to an embodiment, an operation method for a remote UE in a wireless communication system comprises: receiving, by a remote UE, information related to a positioning reference signal (PRS) transmitted by a plurality of base stations; receiving, by the remote UE, a plurality of PRSs from at least some of the plurality of base stations; and measuring, by the remote UE, a reference signal Time difference measurement (RSTD) of each pair of the plurality of PRSs, wherein the at least some of the base stations must include, among the base stations measured by the remote UE, a base station having the best signal strength or a recommended base station of the remote UE.

### TECHNICAL FIELD

The present disclosure relates to a wireless communication system and, more particularly, to a method and apparatus for determining a base station (BS) to transmit a positioning reference signal (PRS) with respect to a remote user equipment (UE) in a sidelink relay and determining the location of the remote UE based on the PRS.

### BACKGROUND

Wireless communication systems are being widely deployed to provide various types of communication services such as voice and data. In general, a wireless communication system is a multiple access system capable of supporting communication with multiple users by sharing available system resources (bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system, and a multi carrier frequency division multiple access (MC-FDMA) system.

A wireless communication system uses various radio access technologies (RATs) such as long term evolution (LTE), LTE-advanced (LTE-A), and wireless fidelity (WiFi). 5th generation (5G) is such a wireless communication system. Three key requirement areas of 5G include (1) enhanced mobile broadband (eMBB), (2) massive machine type communication (mMTC), and (3) ultra-reliable and low latency communications (URLLC). Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is augmented reality (AR) for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup can be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G

Finally, logistics and freight tracking are important use cases for mobile communications that enable the tracking of inventory and packages wherever they are by using location-based information systems. The logistics and freight tracking use cases typically require lower data rates but need wide coverage and reliable location information.

A wireless communication system is a multiple access system that supports communication of multiple users by sharing available system resources (a bandwidth, transmission power, etc.). Examples of multiple access systems include a CDMA system, an FDMA system, a TDMA system, an OFDMA system, an SC-FDMA system, and an MC-FDMA system.

Sidelink (SL) refers to a communication scheme in which a direct link is established between user equipments (UEs) and the UEs directly exchange voice or data without intervention of a base station (BS). SL is considered as a solution of relieving the BS of the constraint of rapidly growing data traffic.

Vehicle-to-everything (V2X) is a communication technology in which a vehicle exchanges information with another vehicle, a pedestrian, and infrastructure by wired/wireless communication. V2X may be categorized into four types: vehicle-to-vehicle (V2V), vehicle-to-infrastructure (V2I), vehicle-to-network (V2N), and vehicle-to-pedestrian (V2P). V2X communication may be provided via a PC5 interface and/or a Uu interface.

As more and more communication devices demand larger communication capacities, there is a need for enhanced mobile broadband communication relative to existing RATs. Accordingly, a communication system is under discussion, for which services or UEs sensitive to reliability and latency are considered. The next-generation RAT in which eMBB, MTC, and URLLC are considered is referred to as new RAT or NR. In NR, V2X communication may also be supported.

FIG. 1 is a diagram illustrating V2X communication based on pre-NR RAT and V2X communication based on NR in comparison.

For V2X communication, a technique of providing safety service based on V2X messages such as basic safety message (BSM), cooperative awareness message (CAM), and decentralized environmental notification message (DENM) was mainly discussed in the pre-NR RAT. The V2X message may include location information, dynamic information, and attribute information. For example, a UE may transmit a CAM of a periodic message type and/or a DENM of an event-triggered type to another UE.

For example, the CAM may include basic vehicle information including dynamic state information such as a direction and a speed, vehicle static data such as dimensions, an external lighting state, path details, and so on. For example, the UE may broadcast the CAM which may have a latency less than 100 ms. For example, when an unexpected incident occurs, such as breakage or an accident of a vehicle, the UE may generate the DENM and transmit the DENM to another UE. For example, all vehicles within the transmission range of the UE may receive the CAM and/or the DENM. In this case, the DENM may have priority over the CAM.

In relation to V2X communication, various V2X scenarios are presented in NR. For example, the V2X scenarios include vehicle platooning, advanced driving, extended sensors, and remote driving.

For example, vehicles may be dynamically grouped and travel together based on vehicle platooning. For example, to perform platoon operations based on vehicle platooning, the vehicles of the group may receive periodic data from a leading vehicle. For example, the vehicles of the group may widen or narrow their gaps based on the periodic data.

For example, a vehicle may be semi-automated or full-automated based on advanced driving. For example, each vehicle may adjust a trajectory or maneuvering based on data obtained from a nearby vehicle and/or a nearby logical entity. For example, each vehicle may also share a dividing intention with nearby vehicles.

Based on extended sensors, for example, raw or processed data obtained through local sensor or live video data may be exchanged between vehicles, logical entities, terminals of pedestrians and/or V2X application servers. Accordingly, a vehicle may perceive an advanced environment relative to an environment perceivable by its sensor.

Based on remote driving, for example, a remote driver or a V2X application may operate or control a remote vehicle on behalf of a person incapable of driving or in a dangerous environment. For example, when a path may be predicted as in public transportation, cloud computing-based driving may be used in operating or controlling the remote vehicle. For example, access to a cloud-based back-end service platform may also be used for remote driving.

A scheme of specifying service requirements for various V2X scenarios including vehicle platooning, advanced driving, extended sensors, and remote driving is under discussion in NR-based V2X communication.

### DISCLOSURE

### Technical Problem

Embodiment(s) are to provide a configuration for determining a base station (BS) to transmit a positioning reference signal (PRS) with respect to a remote user equipment (UE) and a technology of performing positioning based on the PRS received from the BS.

### Technical Solution

In an aspect of the present disclosure, provided herein is a method of operating a remote user equipment (UE) in a wireless communication system. The method may include: receiving, by the remote UE, information on a positioning reference signal (PRS) transmitted by a plurality of base stations (BSs); receiving, by the remote UE, a plurality of PRSs from at least some BSs among the plurality of BSs; and measuring, by the remote UE, a reference signal time difference (RSTD) for each pair of PRSs among the plurality of PRSs. The at least some BSs may necessarily include a BS with a best signal strength among BSs measured by the remote UE or a recommended BS of the remote UE.

In an aspect of the present disclosure, provided herein is a remote UE in a wireless communication system. The remote UE may include: at least one processor; and at least one computer memory operably connected to the at least one processor and configured to store instructions that, when executed, cause the at least one processor to perform operations. The operations may include: receiving information on a PRS transmitted by a plurality of BSs; receiving a plurality of PRSs from at least some BSs among the plurality of BSs; and measuring an RSTD for each pair of PRSs among the plurality of PRSs. The at least some BSs may necessarily include a BS with a best signal strength among BSs measured by the remote UE or a recommended BS of the remote UE.

In an aspect of the present disclosure, provided herein is a processor configured to perform operations for a remote UE in a wireless communication system. The operations may include: receiving information on a PRS transmitted by a plurality of BSs; receiving a plurality of PRSs from at least some BSs among the plurality of BSs; and measuring an RSTD for each pair of PRSs among the plurality of PRSs. The at least some BSs may necessarily include a BS with a best signal strength among BSs measured by the remote UE or a recommended BS of the remote UE.

In a further aspect of the present disclosure, provided herein is a non-volatile computer-readable storage medium configured to store at least one computer program comprising instructions that, when executed by at least one processor, cause the at least one processor to perform operations for a remote UE. The operations may include: receiving information on a PRS transmitted by a plurality of BSs; receiving a plurality of PRSs from at least some BSs among the plurality of BSs; and measuring an RSTD for each pair of PRSs among the plurality of PRSs. The at least some BSs may necessarily include a BS with a best signal strength among BSs measured by the remote UE or a recommended BS of the remote UE.

The remote UE may transmit information on the BS with the best signal strength or the recommended BS of the remote UE to a serving BS.

In determining a location, the remote UE may necessarily use a PRS from the BS with the best signal strength or a PRS from the recommended BS of the remote UE, where the BSs are reported by the remote UE.

In determining a location, the remote UE skips performing measurements on a serving cell.

The remote UE may determine a location of the remote UE based on measurement results.

The remote UE may transmit measurement results to a serving cell and receives information on a location of the remote UE determined by a location management function (LMF) based on the measurement results.

The information on the BS with the best signal strength or the recommended BS of the remote UE may be included in an on-demand system information block (SIB) request transmitted by the remote UE to a serving BS through a relay UE.

The information on the PRS transmitted by the plurality of BSs may be included in a positioning SIB (proSIB).

The proSIB may include a PRS configuration related to the plurality of BSs.

The proSIB may be transmitted by a serving BS of a relay UE.

A serving BS of a relay UE may be identical to a serving BS of the remote UE.

The remote UE may communicate with at least one of another UE, a UE related to an autonomous vehicle, a BS, or a network.

### Advantageous Effects

According to one embodiment, a remote user equipment (UE) may perform accurate and stable positioning even when the remote UE is far from a serving cell.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram comparing vehicle-to-everything (V2X) communication based on pre-new radio access technology (pre-NR) with V2X communication based on NR;

FIG. 2 is a diagram illustrating the structure of a long term evolution (LTE) system according to an embodiment of the present disclosure;

FIG. 3 is a diagram illustrating user-plane and control-plane radio protocol architectures according to an embodiment of the present disclosure;

FIG. 4 is a diagram illustrating the structure of an NR system according to an embodiment of the present disclosure;

FIG. 5 is a diagram illustrating functional split between a next generation radio access network (NG-RAN) and a 5th generation core network (5GC) according to an embodiment of the present disclosure;

FIG. 6 is a diagram illustrating the structure of an NR radio frame to which embodiment(s) of the present disclosure is applicable;

FIG. 7 is a diagram illustrating a slot structure of an NR frame according to an embodiment of the present disclosure;

FIG. 8 is a diagram illustrating radio protocol architectures for sidelink (SL) communication according to an embodiment of the present disclosure;

FIG. 9 is a diagram illustrating radio protocol architectures for SL communication according to an embodiment of the present disclosure;

FIG. 10 is a diagram illustrating a procedure for performing V2X or SL communication by a UE according to a transmission mode;

FIG. 11 to FIG. 15 are diagrams to describe embodiment(s); and

FIGS. 16 to 22 are diagrams illustrating various devices to which embodiment(s) are applicable.

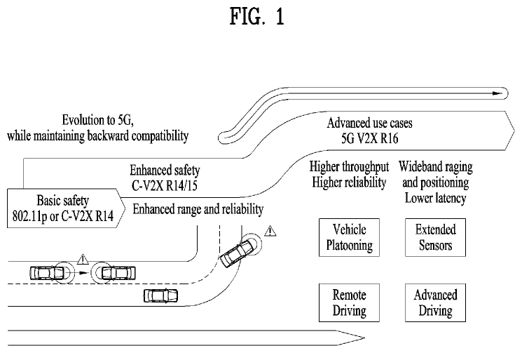

### DETAILED DESCRIPTION

In various embodiments of the present disclosure, “/” and “,” should be interpreted as “and/or”. For example, “A/B” may mean “A and/or B”. Further, “A, B” may mean “A and/or B”. Further, “A/B/C” may mean “at least one of A, B and/or C”. Further, “A, B, C” may mean “at least one of A, B and/or C”.

In various embodiments of the present disclosure, “or” should be interpreted as “and/or”. For example, “A or B” may include “only A”, “only B”, and/or “both A and B”. In other words, “or” should be interpreted as “additionally or alternatively”.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA), or the like. IEEE 802.16m is an evolution of IEEE 802.16e, offering backward compatibility with an IRRR 802.16e-based system. UTRA is a part of universal mobile telecommunications system (UMTS). 3rd generation partnership project (3GPP) long term evolution (LTE) is a part of evolved UMTS (E-UMTS) using evolved UTRA (E-UTRA). 3GPP LTE employs OFDMA for downlink (DL) and SC-FDMA for uplink (UL). LTE-advanced (LTE-A) is an evolution of 3GPP LTE.

A successor to LTE-A, 5th generation (5G) new radio access technology (NR) is a new clean-state mobile communication system characterized by high performance, low latency, and high availability. 5G NR may use all available spectral resources including a low frequency band below 1 GHZ, an intermediate frequency band between 1 GHz and 10 GHz, and a high frequency (millimeter) band of 24 GHz or above.

While the following description is given mainly in the context of LTE-A or 5G NR for the clarity of description, the technical idea of an embodiment of the present disclosure is not limited thereto.

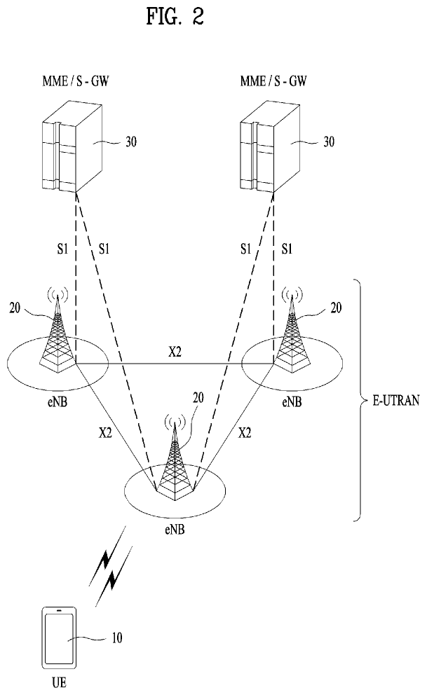

FIG. 2 illustrates the structure of an LTE system according to an embodiment of the present disclosure. This may also be called an evolved UMTS terrestrial radio access network (E-UTRAN) or LTE/LTE-A system.

Referring to FIG. 2, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

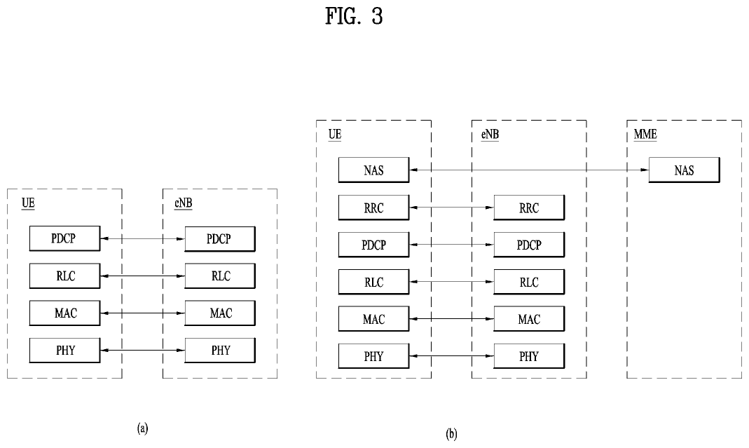

FIG. 3(a) illustrates a user-plane radio protocol architecture according to an embodiment of the disclosure.

FIG. 3(b) illustrates a control-plane radio protocol architecture according to an embodiment of the disclosure. A user plane is a protocol stack for user data transmission, and a control plane is a protocol stack for control signal transmission.

Referring to FIGS. 3(a) and 3(b), the PHY layer provides an information transfer service to its higher layer on physical channels. The PHY layer is connected to the medium access control (MAC) layer through transport channels and data is transferred between the MAC layer and the PHY layer on the transport channels. The transport channels are divided according to features with which data is transmitted via a radio interface.

Data is transmitted on physical channels between different PHY layers, that is, the PHY layers of a transmitter and a receiver. The physical channels may be modulated in orthogonal frequency division multiplexing (OFDM) and use time and frequencies as radio resources.

The MAC layer provides services to a higher layer, radio link control (RLC) on logical channels. The MAC layer provides a function of mapping from a plurality of logical channels to a plurality of transport channels. Further, the MAC layer provides a logical channel multiplexing function by mapping a plurality of logical channels to a single transport channel. A MAC sublayer provides a data transmission service on the logical channels.

The RLC layer performs concatenation, segmentation, and reassembly for RLC serving data units (SDUs). In order to guarantee various quality of service (QOS) requirements of each radio bearer (RB), the RLC layer provides three operation modes, transparent mode (TM), unacknowledged mode (UM), and acknowledged Mode (AM). An AM RLC provides error correction through automatic repeat request (ARQ).

The RRC layer is defined only in the control plane and controls logical channels, transport channels, and physical channels in relation to configuration, reconfiguration, and release of RBs. An RB refers to a logical path provided by L1 (the PHY layer) and L2 (the MAC layer, the RLC layer, and the packet data convergence protocol (PDCP) layer), for data transmission between the UE and the network.

The user-plane functions of the PDCP layer include user data transmission, header compression, and ciphering. The control-plane functions of the PDCP layer include control-plane data transmission and ciphering/integrity protection.

RB establishment amounts to a process of defining radio protocol layers and channel features and configuring specific parameters and operation methods in order to provide a specific service. RBs may be classified into two types, signaling radio bearer (SRB) and data radio bearer (DRB). The SRB is used as a path in which an RRC message is transmitted on the control plane, whereas the DRB is used as a path in which user data is transmitted on the user plane.

Once an RRC connection is established between the RRC layer of the UE and the RRC layer of the E-UTRAN, the UE is placed in RRC_CONNECTED state, and otherwise, the UE is placed in RRC_IDLE state. In NR, RRC_INACTIVE state is additionally defined. A UE in the RRC_INACTIVE state may maintain a connection to a core network, while releasing a connection from an eNB.

DL transport channels carrying data from the network to the UE include a broadcast channel (BCH) on which system information is transmitted and a DL shared channel (DL SCH) on which user traffic or a control message is transmitted. Traffic or a control message of a DL multicast or broadcast service may be transmitted on the DL-SCH or a DL multicast channel (DL MCH). UL transport channels carrying data from the UE to the network include a random access channel (RACH) on which an initial control message is transmitted and an UL shared channel (UL SCH) on which user traffic or a control message is transmitted.

The logical channels which are above and mapped to the transport channels include a broadcast control channel (BCCH), a paging control channel (PCCH), a common control channel (CCCH), a multicast control channel (MCCH), and a multicast traffic channel (MTCH).

A physical channel includes a plurality of OFDM symbol in the time domain by a plurality of subcarriers in the frequency domain. One subframe includes a plurality of OFDM symbols in the time domain. An RB is a resource allocation unit defined by a plurality of OFDM symbols by a plurality of subcarriers. Further, each subframe may use specific subcarriers of specific OFDM symbols (e.g., the first OFDM symbol) in a corresponding subframe for a physical DL control channel (PDCCH), that is, an L1/L2 control channel. A transmission time interval (TTI) is a unit time for subframe transmission.

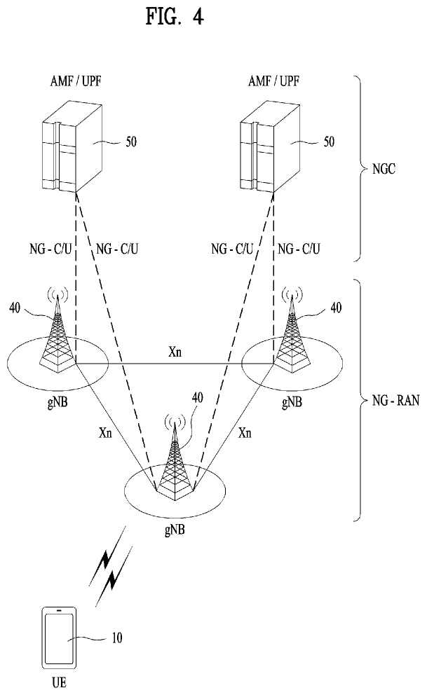

FIG. 4 illustrates the structure of an NR system according to an embodiment of the present disclosure.

Referring to FIG. 4, a next generation radio access network (NG-RAN) may include a next generation Node B (gNB) and/or an eNB, which provides user-plane and control-plane protocol termination to a UE. In FIG. 4, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

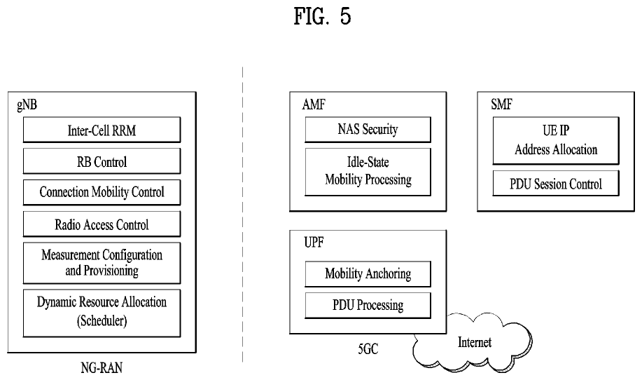

FIG. 5 illustrates functional split between the NG-RAN and the 5GC according to an embodiment of the present disclosure.

Referring to FIG. 5, a gNB may provide functions including inter-cell radio resource management (RRM), radio admission control, measurement configuration and provision, and dynamic resource allocation. The AMF may provide functions such as non-access stratum (NAS) security and idle-state mobility processing. The UPF may provide functions including mobility anchoring and protocol data unit (PDU) processing. A session management function (SMF) may provide functions including UE Internet protocol (IP) address allocation and PDU session control.

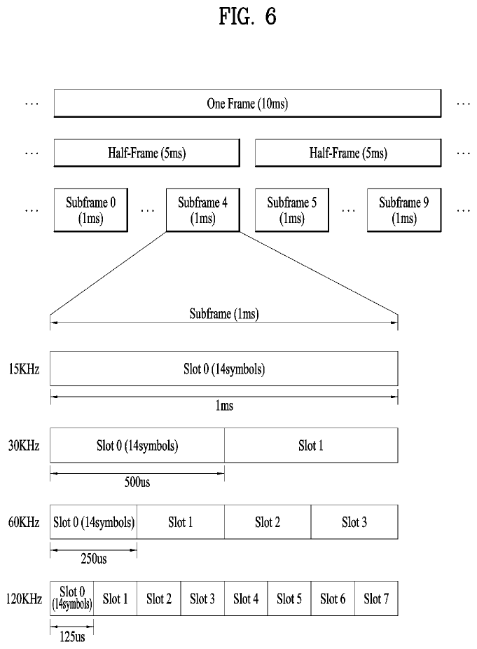

FIG. 6 illustrates a radio frame structure in NR, to which embodiment(s) of the present disclosure is applicable.

Referring to FIG. 6, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM (A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot Nslotsymb, the number of slots per frame Nframe, uslot, and the number of slots per subframe Nsubframe, uslot according to an SCS configuration μ in the NCP case.

TABLE 1

| | | | |
|---|---|---|---|
| SCS (15*2u) | N^{slot}_{symb} | N^{frame, u}ₛₗₒₜ | N^{subframe, u}ₛₗₒₜ |

| | | | | |
|---|---|---|---|---|
| 15 kHz | (u = 0) | 14 | 10 | 1 |
| 30 kHz | (u = 1) | 14 | 20 | 2 |
| 60 kHz | (u = 2) | 14 | 40 | 4 |
| 120 kHz | (u = 3) | 14 | 80 | 8 |
| 240 kHz | (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 kHz (u = 2) | 12 | 40 | 4 |

In the NR system, different OFDM (A) numerologies (e.g., SCSs, CP lengths, and so on) may be configured for a plurality of cells aggregated for one UE. Accordingly, the (absolute time) duration of a time resource including the same number of symbols (e.g., a subframe, slot, or TTI) (collectively referred to as a time unit (TU) for convenience) may be configured to be different for the aggregated cells.

In NR, various numerologies or SCSs may be supported to support various 5G services. For example, with an SCS of 15 kHz, a wide area in traditional cellular bands may be supported, while with an SCS of 30/60 kHz, a dense urban area, a lower latency, and a wide carrier bandwidth may be supported. With an SCS of 60 kHz or higher, a bandwidth larger than 24.25 GHz may be supported to overcome phase noise.

An NR frequency band may be defined by two types of frequency ranges, FR1 and FR2. The numerals in each frequency range may be changed. For example, the two types of frequency ranges may be given in [Table 3]. In the NR system, FR1 may be a “sub 6 GHz range” and FR2 may be an “above 6 GHz range” called millimeter wave (mmW).

TABLE 3

| Frequency | Corresponding frequency | Subcarrier Spacing |
|---|---|---|
| Range designation | range | (SCS) |
| FR1 | 450 MHz-6000 MHz | 15, 30, 60 kHz |
| FR2 | 24250 MHz-52600 MHz | 60, 120, 240 kHz |

As mentioned above, the numerals in a frequency range may be changed in the NR system. For example, FR1 may range from 410 MHz to 7125 MHz as listed in [Table 4]. That is, FR1 may include a frequency band of 6 GHz (or 5850, 5900, and 5925 MHz) or above. For example, the frequency band of 6 GHz (or 5850, 5900, and 5925 MHz) or above may include an unlicensed band. The unlicensed band may be used for various purposes, for example, vehicle communication (e.g., autonomous driving).

TABLE 4

| Frequency | Corresponding frequency | Subcarrier Spacing |
|---|---|---|
| Range designation | range | (SCS) |
| FR1 | 410 MHz-7125 MHz | 15, 30, 60 kHz |
| FR2 | 24250 MHz-52600 MHz | 60, 120, 240 kHz |

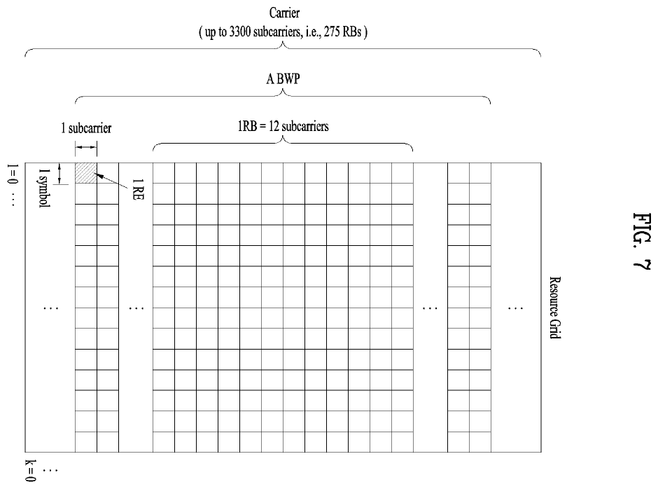

FIG. 7 illustrates a slot structure in an NR frame according to an embodiment of the present disclosure.

Referring to FIG. 7, a slot includes a plurality of symbols in the time domain. For example, one slot may include 14 symbols in an NCP case and 12 symbols in an ECP case. Alternatively, one slot may include 7 symbols in an NCP case and 6 symbols in an ECP case.

A carrier includes a plurality of subcarriers in the frequency domain. An RB may be defined by a plurality of (e.g., 12) consecutive subcarriers in the frequency domain. A bandwidth part (BWP) may be defined by a plurality of consecutive (physical) RBs ((P) RBs) in the frequency domain and correspond to one numerology (e.g., SCS, CP length, or the like). A carrier may include up to N (e.g., 5) BWPs. Data communication may be conducted in an activated BWP. Each element may be referred to as a resource element (RE) in a resource grid, to which one complex symbol may be mapped.

A radio interface between UEs or a radio interface between a UE and a network may include L1, L2, and L3. In various embodiments of the present disclosure, L1 may refer to the PHY layer. For example, L2 may refer to at least one of the MAC layer, the RLC layer, the PDCH layer, or the SDAP layer. For example, L3 may refer to the RRC layer.

Now, a description will be given of sidelink (SL) communication.

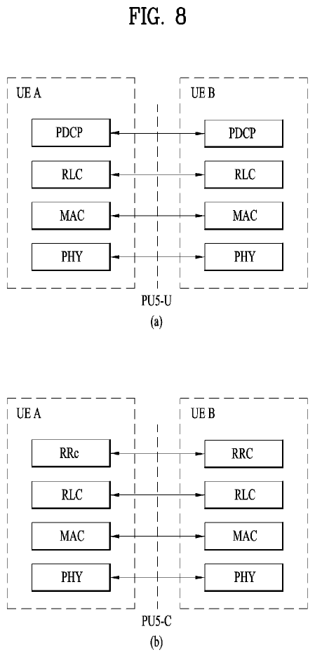

FIG. 8 illustrates a radio protocol architecture for SL communication according to an embodiment of the present disclosure. Specifically, FIG. 8(a) illustrates a user-plane protocol stack in LTE, and FIG. 8(b) illustrates a control-plane protocol stack in LTE.

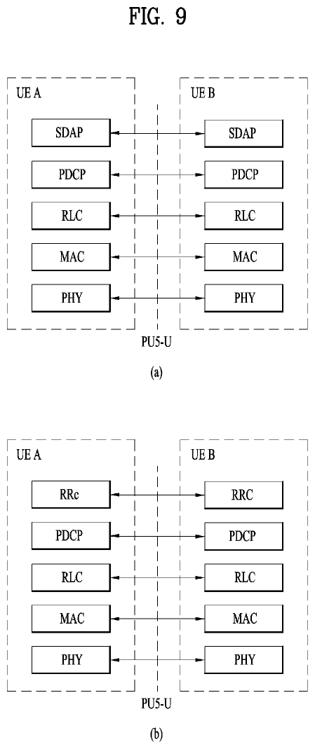

FIG. 9 illustrates a radio protocol architecture for SL communication according to an embodiment of the present disclosure. Specifically, FIG. 9(a) illustrates a user-plane protocol stack in NR, and FIG. 9(b) illustrates a control-plane protocol stack in NR.

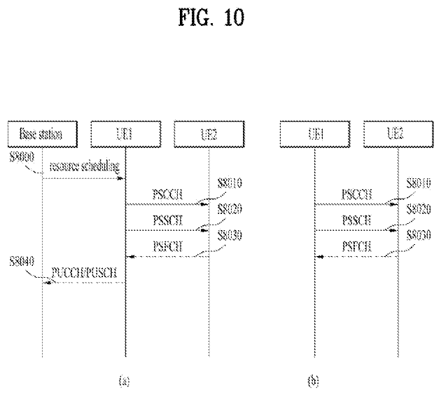

FIG. 10 illustrates a procedure of performing V2X or SL communication by a UE depending on a transmission mode according to an embodiment of the present disclosure. The embodiment of FIG. 10 may be combined with various embodiments of the present disclosure. In various embodiments of the present disclosure, a transmission mode may be referred to as a mode or a resource allocation mode. For the convenience of the following description, a transmission mode in LTE may be referred to as an LTE transmission mode, and a transmission mode in NR may be referred to as an NR resource allocation mode.

For example, FIG. 10 (a) illustrates a UE operation related to LTE transmission mode 1 or LTE transmission mode 3. Alternatively, for example, FIG. 10 (a) illustrates a UE operation related to NR resource allocation mode 1. For example, LTE transmission mode 1 may apply to general SL communication, and LTE transmission mode 3 may apply to V2X communication.

For example, FIG. 10 (b) illustrates a UE operation related to LTE transmission mode 2 or LTE transmission mode 4. Alternatively, for example, FIG. 10 (b) illustrates a UE operation related to NR resource allocation mode 2.

Referring to FIG. 10 (a), in LTE transmission mode 1, LTE transmission mode 3, or NR resource allocation mode 1, a BS may schedule an SL resource to be used for SL transmission by a UE. For example, in a step S8000, the BS may transmit information related to an SL resource and/or information related to a UE resource to a first UE. For example, the UL resource may include a PUCCH resource and/pr a PUSCH resource. For example, the UL resource may be a resource to report SL HARQ feedback to the BS.

For example, a first UE may receive information related to a Dynamic Grant (DG) resource and/or information related to a Configured Grant (CG) resource from a BS. For example, the CG resource may include a CG type 1 resource or a CG type 2 resource. In the present specification, the DG resource may be a resource that the BS configures/allocates to the first UE over Downlink Control Information (DCI). In the present specification, the CG resource may be a (periodic) resource configured/allocated by the BS to the first UE over a DCI and/or an RRC message. For example, in the case of the CG type 1 resource, the BS may transmit an RRC message including information related to the CG resource to the first UE. For example, in the case of the CG type 2 resource, the BS may transmit an RRC message including information related to the CG resource to the first UE, and the BS may transmit DCI related to activation or release of the CG resource to the first UE.

In a step S8010, the first UE may transmit PSCCH (e.g., Sidelink Control Information (SCI) or 1st-stage SCI) to a second UE based on the resource scheduling. In a step S8020, the first UE may transmit PSSCH (e.g., 2nd-stage SCI, MAC PDU, data, etc.) related to the PSCCH to the second UE. In a step S8030, the first UE may receive PSFCH related to the PSCCH/PSSCH from the second UE. For example, HARQ feedback information (e.g., NACK information or ACK information) may be received from the second UE over the PSFCH. In a step S8040, the first UE may transmit/report HARQ feedback information to the BS over PUCCH or PUSCH. For example, the HARQ feedback information reported to the BS may include information generated by the first UE based on HARQ feedback information received from the second UE. For example, the HARQ feedback information reported to the BS may include information generated by the first UE based on a preset rule. For example, the DCI may be a DCI for scheduling of SL. For example, the format of the DCI may include DCI format 3_0 or DCI format 3_1. Table 5 shows one example of DCI for scheduling of SL.

TABLE 5

7.3.1.4.1 Format 3_0
DCI format 3_0 is used for scheduling of NR PSCCH and NR PSSCH in one cell.
The following information is transmitted by means of the DCI format 3_0 with CRC

scrambled by SL-RNTI or SL-CS-RNTI:

| | |
|---|---|
| - | Resource pool index -[log₂ I] bits, where I is the number of resource pools |

for transmission configured by the higher layer parameter sl-TxPoolScheduling.

| | |
|---|---|
| - | Time gap - 3 bits determined by higher layer parameter sl-DCI-ToSL-Trans, |

as defined in clause 8.1.2.1 of [6, TS 38.214]

| | |
|---|---|
| - | HARQ process number - 4 bits. |
| - | New data indicator - 1 bit. |
| - | Lowest index of the subchannel allocation to the initial transmission - |

┌log₂(N_{subChannel}^{SL})┐ bits as defined in clause 8.1.2.2 of [6, TS 38.214]

| | |
|---|---|
| - | SCI format 1-A fields according to clause 8.3.1.1: |
| - | Frequency resource assignment. |
| - | Time resource assignment. |
| - | PSFCH-to-HARQ feedback timing indicator -┌log₂ N_{fb}_{_{—}}_{timing}┐ bits, where |

N_{fb}_{_{—}}_{timing} is the number of entries in the higher layer parameter sl-PSFCH-ToPUCCH, as
defined in clause 16.5 of [5, TS 38.213]

| | |
|---|---|
| - | PUCCH resource indicator - 3 bits as defined in clause 16.5 of [5, TS |

38.213].

| | |
|---|---|
| - | Configuration index - 0 bit if the UE is not configured to monitor DCI format |

3_0 with CRC scrambled by SL-CS-RNTI; otherwise 3 bits as defined in clause 8.1.2 of [6,
TS 38.214]. If the UE is configured to monitor DCI format 3_0 with CRC scrambled by SL-
CS-RNTI, this field is reserved for DCI format 3_0 with CRC scrambled by SL-RNTI.

| | |
|---|---|
| - | Counter sidelink assignment index - 2 bits |
| - | 2 bits as defined in clause 16.5.2 of [5, TS 38.213] if the UE is configured |

with pdsch-HARQ-ACK-Codebook = dynamic

| | |
|---|---|
| - | 2 bits as defined in clause 16.5.1 of [5, TS 38.213] if the UE is configured |

with pdsch-HARQ-ACK-Codebook = semi-static

| | |
|---|---|
| - | Padding bits, if required |

If multiple transmit resource pools are provided in sl-TxPoolScheduling, zeros shall

be appended to the DCI format 3_0 until the payload size is equal to the size of a DCI format
3_0 given by a configuration of the transmit resource pool resulting in the largest number of
information bits for DCI format 3_0.

If the UE is configured to monitor DCI format 3_1 and the number of information

bits in DCI format 3_0 is less than the payload of DCI format 3_1, zeros shall be appended to
DCI format 3_0 until the payload size equals that of DCI format 3_1.

7.3.1.4.2 Format 3_1
DCI format 3_1 is used for scheduling of LTE PSCCH and LTE PSSCH in one cell.
The following information is transmitted by means of the DCI format 3_1 with CRC

scrambled by SL Semi-Persistent Scheduling V-RNTI:

| | |
|---|---|
| - | Timing offset - 3 bits determined by higher layer parameter sl- |

TimeOffsetEUTRA-List, as defined in clause 16.6 of [5, TS 38.213]

| | |
|---|---|
| - | Carrier indicator -3 bits as defined in 5.3.3.1.9A of [11, TS 36.212]. |
| - | Lowest index of the subchannel allocation to the initial transmission - |

┌log₂(N_{subchannel}^{SL})┐ bits as defined in 5.3.3.1.9A of [11, TS 36.212].

| | |
|---|---|
| - | Frequency resource location of initial transmission and retransmission, as |

defined in 5.3.3.1.9A of [11, TS 36.212]

| | |
|---|---|
| - | Time gap between initial transmission and retransmission, as defined in |

5.3.3.1.9A of [11, TS 36.212]

| | |
|---|---|
| - | SL index - 2 bits as defined in 5.3.3.1.9A of [11, TS 36.212] |
| - | SL SPS configuration index - 3 bits as defined in clause 5.3.3.1.9A of [11, TS |

36.212].

| | |
|---|---|
| - | Activation/release indication - 1 bit as defined in clause 5.3.3.1.9A of [11, TS |

36.212].

Referring to FIG. 10 (b), for LTE transmission mode 2, LTE transmission mode 4, or NR resource allocation mode 2, a UE may determine an SL transmission resource from among SL resources configured by a BS/network or preconfigured SL resources. For example, the configured SL resources or preconfigured SL resources may be a resource pool. For example, the UE may autonomously select or schedule resources for SL transmission. For example, the UE may perform SL communication by selecting a resource by itself within a configured resource pool. For example, the UE may perform sensing and resource (re) selection procedures to select a resource by itself within a selection window. For example, the sensing may be performed in unit of a sub-channel. For example, in step S8010, the first UE having self-selected a resource in the resource pool may transmit a PSCCH (e.g., Sidelink Control Information (SCI) or 1^{st}-stage SCI) to the second UE using the resource. In step S8020, the first UE may transmit a PSSCH (e.g., 2^{nd}-stage SCI, MAC PDU, data, etc.) related to the PSCCH to the second UE. In step S8030, the first UE may receive a PSFCH related to the PSCCH/PSSCH from the second UE.

Referring to FIG. 10 (a) or FIG. 10 (b), for example, the first UE may transmit the SCI to the second UE on the PSCCH. Alternatively, for example, the first UE may transmit two consecutive SCIs (e.g., two-stage SCI) to the second UE on the PSCCH and/or PSSCH. In this case, the second UE may decode the two consecutive SCIs (e.g., two-stage SCI) to receive the PSSCH from the first UE. In the present specification, the SCI transmitted on the PSCCH may be referred to as 1st SCI, 1st-stage SCI, or a 1st-stage SCI format, and the SCI transmitted on the PSSCH may be referred to as 2nd SCI, 2nd SCI, or a 2nd-stage SCI format. For example, the 1st-stage SCI format may include SCI format 1-A, and the 2nd-stage SCI format may include SCI format 2-A and/or SCI format 2-B. Table 6 shows one example of a 1st-stage SCI format.

TABLE 6

```
8.3.1.1 SCI format 1-A
  SCI format 1-A is used for the scheduling of PSSCH and 2^{nd}-stage-SCI on PSSCH
  The following information is transmitted by means of the SCI format 1-A:
  - Priority - 3 bits as specified in clause 5.4.3.3 of [12, TS 23.287] and clause
5.22.1.3.1 of [8, TS 38.321]. Value ‘000’ of Priority field corresponds to priority value ‘1’,
value ‘001’ of Priority field corresponds to priority value ‘2’, and so on.
  -  $Frequency resource assignment - ⌈ {log}_{2} ( \frac{{N}_{subChannel}^{SL} ( {N}_{subChannel}^{SL} + 1 )}{2} ) ⌉$
value of the higher layer parameter sl-MaxNumPerReserve is configured to 2; otherwise
$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ bits when the value of the higher layer parameter$
sl-MaxNumPerReserve is configured to 3, as defined in clause 8.1.5 of [6, TS 38.214].
  - Time resource assignment - 5 bits when the value of the higher layer
parameter sl-MaxNumPerReserve is configured to 2; otherwise 9 bits when the value of the
higher layer parameter sl-MaxNumPerReserve is configured to 3, as defined in clause 8.1.5
of [6, TS 38.214].
  - Resource reservation period - ┌log₂ Nᵣₛᵥ_period┐ bits as defined in clause 16.4
of [5, TS 38.213], where Nᵣₛᵥ_period is the number of entries in the higher layer parameter sl-
ResourceReservePeriodList, if higher layer parameter sl-MultiReserveResource is
configured; 0 bit otherwise.
  - DMRS pattern - ┌log₂ Nₚₐₜₜₑᵣₙ┐ bits as defined in clause 8.4.1.1.2 of [4, TS
38.211], where Nₚₐₜₜₑᵣₙ is the number of DMRS patterns configured by higher layer
parameter sl-PSSCH-DMRS-TimePatternList.
  - 2^{nd}-stage SCI format - 2 bits as defined in Table 8.3.1.1-1.
  - Beta_offset indicator - 2 bits as provided by higher layer parameter sl-
BetaOffsets2ndSCI and Table 8.3.1.1-2.
  - Number of DMRS port - 1 bit as defined in Table 8.3.1.1-3.
  - Modulation and coding scheme - 5 bits as defined in clause 8.1.3 of [6, TS
38.214].
  - Additional MCS table indicator - as defined in clause 8.1.3.1 of [6, TS
38.214]: 1 bit if one MCS table is configured by higher layer parameter sl-Additional-MCS-
Table; 2 bits if two MCS tables are configured by higher layer parameter sl-Additional-MCS-
Table; 0 bit otherwise.
  - PSFCH overhead indication - 1 bit as defined clause 8.1.3.2 of [6, TS 38.214]
if higher layer parameter sl-PSFCH-Period = 2 or 4; 0 bit otherwise.
  - Reserved - a number of bits as determined by higher layer parameter sl-
NumReservedBits, with value set to zero.
```

Table 7 shows one example of a 2nd-stage SCI format.

TABLE 7

| | |
|---|---|
| 8.4 | Sidelink control information on PSSCH |

SCI carried on PSSCH is a 2nd-stage SCI, which transports sidelink scheduling

information.

8.4.1 2nd-stage SCI formats
The fields defined in each of the 2^{nd}-stage SCI formats below are mapped to the

information bits a₀ to a_{A-1} as follows:

Each field is mapped in the order in which it appears in the description, with the first

field mapped to the lowest order information bit a₀ and each successive field mapped to
higher order information bits. The most significant bit of each field is mapped to the lowest
order information bit for that field, e.g. the most significant bit of the first field is mapped to
a₀.

| | |
|---|---|
| 8.4.1.1 | SCI format 2-A |

SCI format 2-A is used for the decoding of PSSCH, with HARQ operation when

HARQ-ACK information includes ACK or NACK, when HARQ-ACK information includes
only NACK, or when there is no feedback of HARQ-ACK information.

| The following information is transmitted by means of the SCI format 2-A: | |
|---|---|
| - | HARQ process number - 4 bits. |
| - | New data indicator - 1 bit. |
| - | Redundancy version - 2 bits as defined in Table 7.3.1.1.1-2. |
| - | Source ID - 8 bits as defined in clause 8.1 of [6, TS 38.214]. |
| - | Destination ID - 16 bits as defined in clause 8.1 of [6, TS 38.214]. |
| - | HARQ feedback enabled/disabled indicator - 1 bit as defined in clause 16.3 of |

[5, TS 38.213].

| | |
|---|---|
| - | Cast type indicator - 2 bits as defined in Table 8.4.1.1-1 and in clause 8.1 of [6, |

TS 38.214].

| | |
|---|---|
| - | CSI request - 1 bit as defined in clause 8.2.1 of [6, TS 38.214] and in clause |

8.1 of [6, TS 38.214].

Referring to FIG. 10 (a) or FIG. 10 (b), in step S8030, the first UE may receive the PSFCH based on Table 8. For example, the first UE and the second UE may determine a PSFCH resource based on Table 8, and the second UE may transmit HARQ feedback to the first UE using the PSFCH resource.

TABLE 8

16.3 UE procedure for reporting HARQ-ACK on sidelink
A UE can be indicated by an SCI format scheduling a PSSCH reception to transmit a

PSFCH with HARQ-ACK information in response to the PSSCH reception. The UE provides
HARQ-ACK information that includes ACK or NACK, or only NACK.

A UE can be provided, by sl-PSFCH-Period, a number of slots in a resource pool for

a period of PSFCH transmission occasion resources. If the number is zero, PSFCH
transmissions from the UE in the resource pool are disabled.

A UE expects that a slot tₖ′^{SL} (0 ≤ k < T′ₘₐₓ) has a PSFCH transmission occasion

resource if k mod N_{PSSCH}^{PSFCH} = 0, where tₖ′^{SL} is defined in [6, TS 38.214], and T′ₘₐₓ is a
number of slots that belong to the resource pool within 10240 msec according to [6, TS
38.214], and N_{PSSCH}^{PSFCH} is provided by sl-PSFCH-Period.

A UE may be indicated by higher layers to not transmit a PSFCH in response to a

PSSCH reception [11, TS 38.321].

If a UE receives a PSSCH in a resource pool and the HARQ feedback

enabled/disabled indicator field in an associated SCI format 2-A or a SCI format 2-B has
value 1 [5, TS 38.212], the UE provides the HARQ-ACK information in a PSFCH
transmission in the resource pool. The UE transmits the PSFCH in a first slot that includes
PSFCH resources and is at least a number of slots, provided by sl-MinTimeGapPSFCH, of
the resource pool after a last slot of the PSSCH reception.

A UE is provided by sl-PSFCH-RB-Set a set of M_{PRB, set}^{PSFCH} PRBs in a resource pool for

PSFCH transmission in a PRB of the resource pool. For a number of N_{subch} sub-channels
for the resource pool, provided by sl-NumSubchannel, and a number of PSSCH slots
associated with a PSFCH slot that is less than or equal to N_{PSSCH}^{PSFCH}, the UE allocates the
[(i + j · N_{PSSCH}^{PSFCH}) · M_{subch, slot}^{PSFCH}, (i + 1 + j · N_{PSSCH}^{PSFCH}) · M_{subch, slot}^{PSFCH} − 1] PRBs from the
M_{PRB, set}^{PSFCH} PRBs to slot i among the PSSCH slots associated with the PSFCH slot and sub-
channel j, where M_{subch, slot}^{PSFCH} = M_{PRB, set}^{PSFCH}/(N_{subch} · N_{PSSCH}^{PSFCH}), 0 ≤ i < N_{PSSCH}^{PSFCH}, 0 ≤ j <
N_{subch}, and the allocation starts in an ascending order of i and continues in an ascending
order of j. The UE expects that M_{PRB, set}^{PSFCH} is a multiple of N_{subch} · N_{PSSCH ·}^{PSFCH}.

The second OFDM symbol l′ of PSFCH transmission in a slot is defined as l′ =

sl-StartSymbol + sl-LengthSymbols − 2 .

A UE determines a number of PSFCH resources available for multiplexing HARQ-

ACK information in a PSFCH transmission as R_{PRB, CS}^{PSFCH} = N_{type}^{PSFCH} · M_{subch, slot}^{PSFCH} · N_{CS}^{PSFCH}
where N_{CS}^{PSFCH} is a number of cyclic shift pairs for the resource pool provided by sl-
NumMuxCS-Pair and, based on an indication by sl-PSFCH-CandidateResourceType,

| | |
|---|---|
| - | if sl-PSFCH-CandidateResourceType is configured as startSubCH, N_{type}^{PSFCH} = |

1 and the M_{subch, slot}^{PSFCH} PRBs are associated with the starting sub-channel of the corresponding
PSSCH;

| | |
|---|---|
| - | if sl-PSFCH-CandidateResourceType is configured as allocSubCH, N_{type}^{PSFCH} = |

N_{subch}^{PSSCH} and the N_{subch}^{PSSCH} · M_{subch, slot}^{PSFCH} PRBs are associated with the N_{subch}^{PSSCH} sub-channels
of the corresponding PSSCH.

The PSFCH resources are first indexed according to an ascending order of the PRB

index, from the N_{type}^{PSFCH} · M_{subch, slot}^{PSFCH} PRBs, and then according to an ascending order of the
cyclic shift pair index from the N_{CS}^{PSFCH} cyclic shift pairs.

A UE determines an index of a PSFCH resource for a PSFCH transmission in

response to a PSSCH reception as (P_{ID} + M_{ID})modR_{PRB, CS} ^{PSFCH} where P_{ID} is a physical layer
source ID provided by SCI format 2-A or 2-B [5, TS 38.212] scheduling the PSSCH
reception, and M_{ID} is the identity of the UE receiving the PSSCH as indicated by higher
layers if the UE detects a SCI format 2-A with Cast type indicator field value of “01”;
otherwise, M_{ID} is zero.

A UE determines a m₀ value, for computing a value of cyclic shift α [4, TS 38.211],

from a cyclic shift pair index corresponding to a PSFCH resource index and from
N_{CS}^{PSFCH} using Table 16.3-1.

Referring to FIG. 10 (a), in step S8040, the first UE may transmit SL HARQ feedback to the BS over the PUCCH and/or PUSCH based on Table 9.

TABLE 9

16.5 UE procedure for reporting HARQ-ACK on uplink
A UE can be provided PUCCH resources or PUSCH resources [12, TS 38.331] to

report HARQ-ACK information that the UE generates based on HARQ-ACK information that
the UE obtains from PSFCH receptions, or from absence of PSFCH receptions. The UE
reports HARQ-ACK information on the primary cell of the PUCCH group, as described in
clause 9, of the cell where the UE monitors PDCCH for detection of DCI format 3_0.

For SL configured grant Type 1 or Type 2 PSSCH transmissions by a UE within a time

period provided by sl-PeriodCG, the UE generates one HARQ-ACK information bit in
response to the PSFCH receptions to multiplex in a PUCCH transmission occasion that is after
a last time resource, in a set of time resources.

For PSSCH transmissions scheduled by a DCI format 3_0, a UE generates HARQ-

ACK information in response to PSFCH receptions to multiplex in a PUCCH transmission
occasion that is after a last time resource in a set of time resources provided by the DCI format
3_0.

From a number of PSFCH reception occasions, the UE generates HARQ-ACK

information to report in a PUCCH or PUSCH transmission. The UE can be indicated by a SCI
format to perform one of the following and the UE constructs a HARQ-ACK codeword with
HARQ-ACK information, when applicable

| | |
|---|---|
| - | for one or more PSFCH reception occasions associated with SCI format 2-A |

with Cast type indicator field value of “10”

| | |
|---|---|
| - | generate HARQ-ACK information with same value as a value of HARQ-ACK |

information the UE determines from the last PSFCH reception from the number of PSFCH
reception occasions corresponding to PSSCH transmissions or, if the UE determines that a
PSFCH is not received at the last PSFCH reception occasion and ACK is not received in any
of previous PSFCH reception occasions, generate NACK

| | |
|---|---|
| - | for one or more PSFCH reception occasions associated with SCI format 2-A |

with Cast type indicator field value of “01”

| | |
|---|---|
| - | generate ACK if the UE determines ACK from at least one PSFCH reception |

occasion, from the number of PSFCH reception occasions corresponding to PSSCH
transmissions, in PSFCH resources corresponding to every identity M_{ID} of the UEs that the UE
expects to receive the PSSCH, as described in clause 16.3; otherwise, generate NACK

| | |
|---|---|
| - | for one or more PSFCH reception occasions associated with SCI format 2-B or |

SCI format 2-A with Cast type indicator field value of “11”

| | |
|---|---|
| - | generate ACK when the UE determines absence of PSFCH reception for the |

last PSFCH reception occasion from the number of PSFCH reception occasions corresponding
to PSSCH transmissions; otherwise, generate NACK

After a UE transmits PSSCHs and receives PSFCHs in corresponding PSFCH

resource occasions, the priority value of HARQ-ACK information is same as the priority value
of the PSSCH transmissions that is associated with the PSFCH reception occasions providing
the HARQ-ACK information.

The UE generates a NACK when, due to prioritization, as described in clause 16.2.4,

the UE does not receive PSFCH in any PSFCH reception occasion associated with a PSSCH
transmission in a resource provided by a DCI format 3_0 or, for a configured grant, in a
resource provided in a single period and for which the UE is provided a PUCCH resource to
report HARQ-ACK information. The priority value of the NACK is same as the priority value
of the PSSCH transmission.

The UE generates a NACK when, due to prioritization as described in clause 16.2.4,

the UE does not transmit a PSSCH in any of the resources provided by a DCI format 3_0 or,
for a configured grant, in any of the resources provided in a single period and for which the
UE is provided a PUCCH resource to report HARQ-ACK information. The priority value of
the NACK is same as the priority value of the PSSCH that was not transmitted due to
prioritization.

The UE generates an ACK if the UE does not transmit a PSCCH with a SCI format 1-

A scheduling a PSSCH in any of the resources provided by a configured grant in a single
period and for which the UE is provided a PUCCH resource to report HARQ-ACK
information. The priority value of the ACK is same as the largest priority value among the
possible priority values for the configured grant.

Table 10 below shows disclosed information related to selection and reselection of a sidelink relay UE in 3GPP TS 36.331. The disclosed information in Table 10 is used as the related art of the disclosure, related necessary details refer to 3GPP TS 36.331.

TABLE 10

5.10.11.4 Selection and reselection of sidelink relay UE
A UE capable of sidelink remote UE operation that is configured by upper layers to

search for a sidelink relay UE shall:

| | 1> | if out of coverage on the frequency used for sidelink communication, as |
|---|---|---|
| | defined in TS 36.304 [4], clause 11.4; or | |
| 1> | if the serving frequency is used for sidelink communication and the RSRP | |
| | measurement of the cell on which the UE camps (RRC_IDLE)/ the PCell | |
| | (RRC_CONNECTED) is below threshHigh within remoteUE-Config : | |
| | 2> | search for candidate sidelink relay UEs, in accordance with TS 36.133 [16] |
| | 2> | when evaluating the one or more detected sidelink relay UEs, apply layer 3 |

filtering as specified in 5.5.3.2 across measurements that concern the same ProSe Relay UE
ID and using the filterCoefficient in SystemInformationBlockType19 (in coverage) or the
preconfigured filterCoefficient as defined in 9.3(out of coverage), before using the SD-
RSRP measurement results;

| | |
|---|---|
| NOTE 1: | The details of the interaction with upper layers are up to UE |

implementation.

| | |
|---|---|
| 2> | if the UE does not have a selected sidelink relay UE: |
| 3> | select a candidate sidelink relay UE which SD-RSRP exceeds q-RxLevMin |

included in either reselectionInfoIC (in coverage) or reselectionInfoOoC (out of coverage)
by minHyst;

| | |
|---|---|
| 2> | else if SD-RSRP of the currently selected sidelink relay UE is below q- |

RxLevMin included in either reselectionInfoIC (in coverage) or reselectionInfoOoC (out of
coverage); or if upper layers indicate not to use the currently selected sidelink relay: (i.e.
sidelink relay UE reselection):

| | |
|---|---|
| 3> | select a candidate sidelink relay UE which SD-RSRP exceeds q-RxLevMin |

included in either reselectionInfoIC (in coverage) or reselectionInfoOoC (out of coverage)
by minHyst;

| | |
|---|---|
| 2> | else if the UE did not detect any candidate sidelink relay UE which SD- |

RSRP exceeds q-RxLevMin included in either reselectionInfoIC (in coverage) or
reselectionInfoOoC (out of coverage) by minHyst:

| | |
|---|---|
| 3> | consider no sidelink relay UE to be selected; |
| NOTE 2: | The UE may perform sidelink relay UE reselection in a manner |

resulting in selection of the sidelink relay UE, amongst all candidate sidelink relay UEs
meeting higher layer criteria, that has the best radio link quality. Further details, including
interaction with upper layers, are up to UE implementation.

| 5.10.11.5 | Sidelink remote UE threshold conditions |
|---|---|
| A UE capable of sidelink remote UE operation shall: | |
| 1> | if the threshold conditions specified in this clause were not met: |
| 2> | if threshHigh is not included in remoteUE-Config within |

SystemInformationBlockType19; or

| | |
|---|---|
| 2> | if threshHigh is included in remoteUE-Config within |

SystemInformationBlockType19; and the RSRP measurement of the PCell, or the cell on
which the UE camps, is below threshHigh by hystMax (also included within remoteUE-
Config):

| | |
|---|---|
| 3> | consider the threshold conditions to be met (entry); |

1> else:

| | |
|---|---|
| 2> | if threshHigh is included in remoteUE-Config within |

SystemInformationBlockType19; and the RSRP measurement of the PCell, or the cell on
which the UE camps, is above threshHigh (also included within remoteUE-Config):

| | |
|---|---|
| 3> | consider the threshold conditions not to be met (leave); |

The NG-RAN may support the following positioning methods: global navigation satellite system (GNSS), observed time difference of arrival (OTDOA), enhanced cell ID (E-CID), barometric sensor positioning, wireless local-area network (WLAN) positioning, Bluetooth positioning, terrestrial beacon system (TBS), uplink time difference of arrival (UTDOA), and so on. Although any one of the positioning methods may be used for UE positioning, two or more positioning methods may be used for UE positioning.

### (1) OTDOA (Observed Time Difference of Arrival)

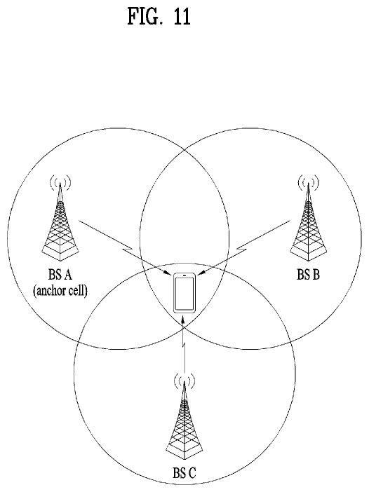

FIG. 11 is a diagram for explaining an OTDOA positioning method according to an embodiment of the present disclosure.

The OTDOA positioning method uses the timing measurements of DL signals received by the UE from multiple TPs including an eNB, an ng-eNB, and a PRS-only TP. The UE measures the timing of received DL signals based on location assistance data received from a location server. The location of the UE may be determined based on the measurement results and the geographical coordinates of neighboring TPs.

When the UE is connected to the gNB, the UE may request a measurement gap for OTDOA measurement from a TP. If the UE does not recognize a single frequency network (SFN) for at least one TP in OTDOA assistance data, the UE may use an autonomous gap to obtain the SFN of an OTDOA reference cell before requesting a measurement gap for reference signal time difference (RSTD) measurement.

Herein, the RSTD may be defined based on the minimum relative time difference between the boundaries of two subframe received from reference and measurement cells. That is, the RSTD may be calculated based on the relative time difference between the start time of a subframe received from the measurement cell and the start time of a subframe from the reference cell, which is closest to the measurement cell. The reference cell may be selected by the UE.

For accurate OTDOA positioning, it is necessary to measure the times of arrival (ToAs) of signals received from three or more geographically distributed TPs or BSs. For example, the ToAs for TP 1, TP 2, and TP 3 may be measured, and the RSTD for TP 1 and TP 2, the RSTD for TP 2 and TP 3, and the RSTD for TP 3 and TP 1 may be calculated based on the three ToAs. Then, geometric hyperbolas may be determined based on the calculated RSTDs, and a point at which the hyperbolas intersect may be estimated as the location of the UE. In this case, due to potential accuracy and/or uncertainty associated with each TOA measurement, the estimated UE location may be provided within a specific range according to measurement uncertainty.

For example, the RSTD for two TPs may be calculated based on Equation 1 below.

$$RSTDi , 1 = \frac{\sqrt{{( {x}_{t} - {x}_{i} )}^{2} + {( {y}_{t} - {y}_{i} )}^{2}}}{c} - \frac{\sqrt{{( {x}_{t} - {x}_{1} )}^{2} + {( {y}_{t} - {y}_{1} )}^{2}}}{c} + ( {T}_{i} - {T}_{1} ) + ( {n}_{i} - {n}_{1} ) \qquad [ Equation 1 ]$$

In Equation 3, c is the speed of light, {xt, yt} are (unknown) coordinates of a target UE, {xi, yi} are (known) coordinates of a TP, and {x1, y1} are coordinates of a reference TP (or another TP). Here, (Ti−T1) is a transmission time offset between two TPs, which may be referred to as real time differences (RTDs), where ni and nl may be values related to UE TOA measurement errors.

### (2) E-CID (Enhanced Cell ID)

In a cell ID (CID) positioning method, the location of the UE may be measured based on geographical information on the serving ng-eNB, serving gNB, and/or serving cell of the UE. For example, the geographical information on the serving ng-eNB, serving gNB, and/or serving cell may be acquired from paging, registration, etc.

In an E-CID positioning method, additional UE measurements and/or NG-RAN radio resources may be further used to improve the performance of UE positioning, compared to the CID positioning method. The E-CID positioning method may partially use the same measurement methods as the measurement control system on an RRC protocol. However, in general, no additional measurement may be performed only for UE positioning. In other words, to estimate the location of the UE, any separate measurement configurations or measurement control messages may not be provided. In addition, the UE may expect that no additional measurement operations will be requested for positioning. The UE may report measurements obtained by general measurement methods.

For example, the serving gNB may implement the E-CID positioning method using E-UTRA measurements provided by the UE.

The following measurement elements may be used for E-CID positioning.
UE measurement: E-UTRA reference signal received power (RSRP), E-UTRA reference signal received quality (RSRQ), UE E-UTRA reception-transmission time difference (Rx-Tx time difference), GERAN (GSM EDGE random access network)/WLAN reference signal strength indication (RSSI), UTRAN common pilot channel (CPICH) received signal code power (RSCP), and/or UE E-UTRA Rx-Tx time difference
E-UTRAN measurement: ng-eNB Rx-Tx time difference, timing advance (TADV), and/or angle of arrival (AoA)

Here, TADV may be divided into Type 1 and Type 2 as follows.
TADV Type 1=(ng-eNB Rx-Tx time difference)+(UE E-UTRA Rx-Tx time difference)
TADV Type 2=ng-eNB Rx-Tx time difference

AoA may be used to measure the direction of the UE. AoA may be defined as the estimated angle of the UE in the counterclockwise direction from the BS/TP. In this case, the geographical reference direction may be north. The BS/TP may use an UL signal such as a sounding reference signal (SRS) and/or a demodulation reference signal (DMRS) for AoA measurement. In addition, the larger the size of antenna arrays, the higher the measurement accuracy of AoA. When the antenna arrays are placed at the same interval, signals received at adjacent antenna elements may have a consistent phase rotation.

### (3) UTDOA (Uplink Time Difference of Arrival)

UTDOA positioning is a method of determining the location of the UE by estimating the time of arrival of an SRS. To estimate the time of arrival of the SRS, the serving cell may be used as the reference cell. Then, the location of the UE may be calculated based on the difference in the time of arrival with respect to another cell (or BS/TP). To implement the UTDOA, the evolved serving mobile location center (E-SMLC) may indicate the serving cell of a target UE to instruct the target UE to perform SRS transmission. The E-SMLC may provide configurations such as SRS periodicity/aperiodicity, bandwidth, and frequency/group/sequence hopping.

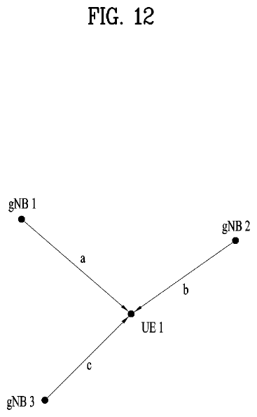

UE positioning methods may be broadly categorized into two types. The UE may perform positioning itself. The UE may calculate the location thereof based on the time difference of arrival (TDoA) method by measuring a positioning reference signal (PRS) transmitted by the gNB (BS). For example, in FIG. 12, UE1 receives a PRS from each of gNB1, gNB2, and gNB3. UE1 may calculate the location thereof by calculating the time differences between the location of each gNB and the PRSs received via links (a, b), (a, c), and (b, c). To this ends, it is assumed that UE1 knows the location of each gNB in advance.

As another method, UE1 may transmit the time difference between PRSs measured by UE1 to the serving cell of UE1, and a location management function (LMF) connected to the serving cell may calculate the location of UEL and then transmit the calculated location to UE1. UE1 reports the time difference (RSTD) between PRSs received from the serving gNB and other nearby gNBs together with gNB IDs (cell IDs) to the serving cell. In this case, UE1 does not need to know the location of each gNB because the LMF knows the location of each gNB. The LMF calculates the location of the UE based on the PRSs received from the UE and transmits the calculated location to the corresponding UE.

In both of the above cases, it is assumed that UE1 is in the RRC CONNECTED state with the serving of UE1. The second method based on the LMF is introduced into specifications first, and in this case, it is only possible when the UE is in the RRC CONNECTED state. In the first method where the UE measures the location thereof, the UE does not need to be in the RRC CONNECTED state with the serving cell. However, according to the current specifications, this operation is limitedly applied when the UE is in the RRC CONNECTED state. This determination is made under the assumption that information on positioning will be eventually managed by a core network (CN), but this may change when sidelink (SL) positioning is introduced (Rel-18). In addition, the CN may have the estimated UE location, but the CN may only know the approximate location or may not know the location. Several gNBs around the serving gNB may be configured to transmit PRSs, and the UE may calculate several time differences between the PRSs and report the calculation results (RSTD) to the LMF.

According to the LTE Release 16 Uu positioning specifications, the serving BS/transmission-reception point (TRP) of the UE needs to be included in a set of BSs/TRPs that perform PRS transmission. As described above, the target UE related to positioning is limited to be in the RRC CONNECTED state. This is because a PRS transmitted by the serving BS/TRP is assumed to have the best quality from the perspective of the UE.

If relay and remote UEs are camping on the same cell, the relay UE may transmit a positioning SIB (posSIB) to the remote UE, and the remote UE may know the locations of neighboring gNBs and the serving cell thereof based on the configuration of the posSIB. Accordingly, the remote UE may estimate the location thereof based on the UE-based and LMF-based methods described above.

However, when the relay and remote UEs have different best RSRP BSs/TRPs, or when the relay and remote UEs have different recommended reference BSs/TRPs required for RSTD measurement related to positioning, different operations from the conventional operations may be considered. For example, such a case may refer to when one UE (relay or remote UE) uses TRP #½ to measure RSTD #1 and uses TRP #⅔ to measure RSTD #2.

Hereinafter, the present disclosure proposes a method of measuring the location of the remote UE when the remote and relay UEs have different best RSRP BSs/TRPs or when the remote and relay UEs have different recommended reference BSs/TRPs required for RSTD measurement related to positioning.

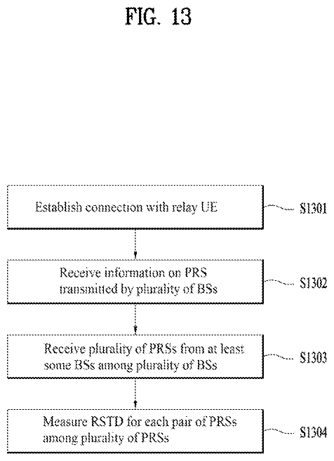

According to an embodiment, a remote UE may establish a connection with a relay UE (S1301 in FIG. 13). The remote UE may receive information on a PRS transmitted by a plurality of BSs (S1301). The remote UE may receive a plurality of PRSs from at least some BSs among the plurality of BSs based on the information on the PRS (S1303). The remote UE may measure an RSTD for each pair of PRSs among the plurality of PRSs (S1304).

The at least some BSs may necessarily include a BS with the best signal strength among BSs measured by the remote UE or a recommended BS of the remote UE. To this end, the remote UE may transmit information on the BS with the best signal strength or the recommended BS of the remote UE to a serving BS. In determining the location thereof, the remote UE may necessarily use a PRS from the BS with the best signal strength or a PRS from the recommended BS of the remote UE, which are reported by the remote UE.

In other words, the remote UE may receive the plurality of PRSs from the at least some BSs, measure the RSTD of each pair of PRSs among the plurality of PRSs, and then directly determine the location based on the measured RSTD. Alternatively, the remote UE may transmit measurement results to a serving cell and receive information on the location of the remote UE determined by a LMF based on the measurement results. In this case, BS(s) that transmit PRSs used to determine the location of the remote UE necessarily include the BS with the best signal strength among the BSs measured by the remote UE or the recommended BS of the remote UE. In other words, the BS with the best signal strength with respect to the remote UE or the recommended BS of the remote UE (or PRSs transmitted by the BSs) need to be used in determining the location of the remote UE.

According to the above-described configuration, it is possible to prevent an increase in the error of estimating the location of the remote UE due to the distance between the remote and relay UEs, compared to the prior art where a measurement target, i.e., a BS that performs PRS transmission is determined based on the relay UE. Specifically, when the remote and relay UEs have different best RSRP BSs/TRPs, or when the remote and relay UEs have different recommended reference BSs/TRPs required for RSTD measurement related to positioning, it may be difficult for the remote UE to receive a PRS directly from the serving cell thereof. The reason for this is that since the serving cell of the remote UE is always considered as the serving cell of the relay UE, the remote UE may have a significant physical distance from the serving cell.

According to the configuration of the embodiment described above, the BS with respect to the remote UE (i.e., the BS with the best signal strength or the recommended BS of the remote UE) (or PRSs transmitted by the BSs) may be necessarily used in determining the location of the remote UE, thereby reducing measurement errors.

Before establishing the connection, the remote UE may have as the serving cell a cell other than the serving cell of the relay UE. In other words, the remote and relay UEs may exist on different cells. Alternatively, the above case may include the following cases: when the remote and relay UEs have different best RSRP BSs/TRPs and when the remote and relay UEs have different recommended reference BSs/TRPs required for RSTD measurement related to positioning. However, it should be noted that the above content does not necessarily mean that the embodiments described herein are exclusively applicable/used only in such cases, and the embodiments according to the present disclosure may also be applicable/used in cases other than those described above. Additionally, the remote UE may not perform measurements on the serving cell in determining the location. When the distance between the remote UE and the serving cell is large as in the case exemplified above, it is expected that the serving cell does not correspond to one of the plurality of BSs that transmitted the PRSs for RSTD measurement, and thus the remote UE may not perform measurements on the serving cell.

The information on the BS with the best signal strength or the recommended BS of the remote UE may be included in an on-demand SIB request transmitted by the remote UE to the serving BS through the relay UE. The information on the PRS transmitted by the plurality of BSs may be included in a proSIB. The proSIB may include a PRS configuration related to the plurality of BSs. The proSIB may be transmitted by the serving BS of the relay UE. The serving BS of the relay UE may be identical to the serving BS of the remote UE.

As described above, the remote UE may determine the location of the remote UE based on the measurement results. Alternatively, the remote UE may transmit the measurement results to the serving cell and receive the information on the location of the remote UE determined by the LMF based on the measurement results. Hereinafter, each of the two cases will be described in detail.

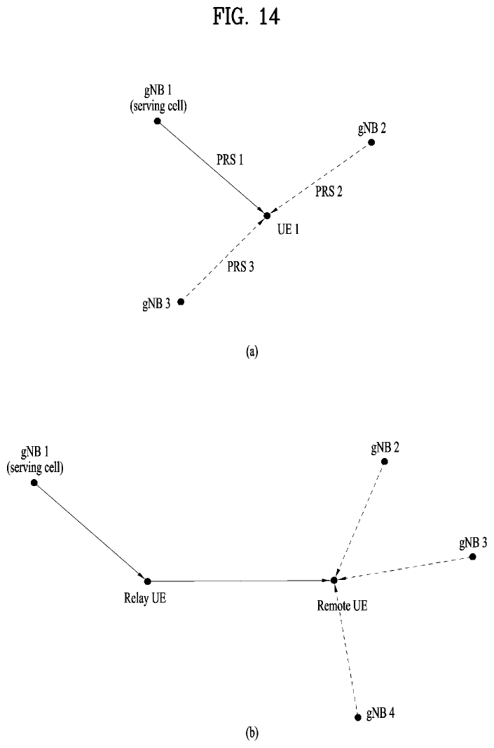

FIG. 14 (a) illustrates a conventional UE-based positioning method. UE1, which intends to perform the positioning operation, calculates the time difference between a PRS transmitted from a serving cell and a PRS transmitted from another gNB based on a configured value in a posSIB transmitted from the serving cell to estimate the location of UE1. In this case, a CN configures gNBs to transmit PRSs for UE1. The selected gNBs need to include a serving cell gNB (and/or CONNECTED gNB) of UE1 (because the service cell corresponds to a cell with the best signal strength from the perspective of UE1). The CN may select multiple gNBs around UE1 and also provide information on the locations of the multiple gNBs. When the UE intends to calculate location information, the UE needs to select a gNB located in a position that forms a triangle around the UE, if possible, to achieve accurate positioning.

On the other hand, FIG. 14 (b) illustrates a UE-based positioning method according to an embodiment of the present disclosure. Referring to FIG. 14 (b), when a remote UE sends a request for an on-demand SIB related to a posSIB to the serving cell of the remote UE through a relay UE, the remote UE may also transmit information (e.g., cell ID, gNB ID, etc.) on a gNB that transmitted the best RSRP measured by the remote UE. The CN of gNB1, which is the serving cell of the remote UE, configures gNBs in the cell where the remote UE exists to transmit a PRS to the remote UE and transmits the posSIB to the remote UE. That is, upon receiving the above information, the CN transmits posSIB information containing a PRS configuration for neighboring gNBs capable of transmitting the PRS to be measured by the remote UE and information on the locations of the gNBs. In this case, information on (and/or a list of) the gNBs capable of transmitting the PRS, which may be carried by the posSIB, may be configured to necessarily include gNB information based on the best RSRP gNB/TRP measured by the remote UE and the recommended reference gNB/TRP of the remote UE. Alternatively, the remote UE may transmit a list of cell IDs (gNB IDs) where the remote UE is capable of receiving signals (e.g., based on the strength of a signal such as MIB, SIBI, etc. from its own camping cell and neighboring cells) as assistance information. The purpose of the assistance information is to facilitate the CN to determine neighboring cells (gNBs) where the remote UE is capable of easily receiving the PRS.

The remote UE may exclude an operation of measuring the PRS of the serving cell with which the remote UE is RRC CONNECTED when conventional UEs perform positioning. Instead, the remote UE may be configured to calculate the location thereof by always including the PRS measurement of the best RSRP gNB/TRP measured by the remote UE and the PRS measurement of the gNB considered (reported) by the remote UE as the recommended reference gNB/TRP. In other words, the remote UE may measure the time difference between PRSs transmitted from neighboring gNBs configured by the CN, but the remote UE may be configured to necessarily include the PRS from the best RSRP gNB/TRP measured by the remote UE and the PRS from the recommended reference gNB/TRP in measuring the time differences for RSTD calculation.

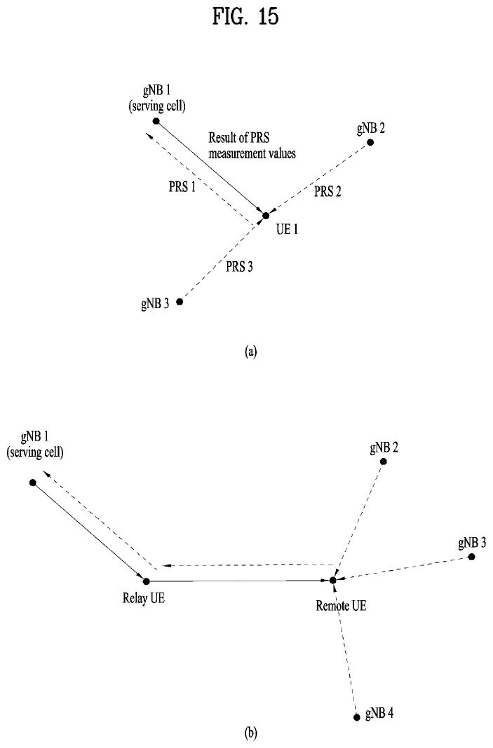

FIG. 15 illustrates LMF-based positioning methods for a remote UE. Specifically, FIG. 15 shows a conventional LMF-based positioning method for a remote UE (FIG. 15 (a)) and an LMF-based positioning method for a remote UE according to the present disclosure (FIG. 15 (b)).

Referring to FIG. 15 (a), when the UE intends to perform the positioning operation, the UE should be in the RRC CONNECTED state with a serving cell and receive a posSIB from the serving cell. A gNB from which the UE measures a PRS is determined based on the received posSIB information. The UE reports to the serving cell a PRS time difference (RSTD) measured by the UE and information (e.g., gNB ID) on a gNB that transmits the PRS corresponding to the calculated value. The serving cell forwards the information reported by the UE to a CN, and an LMF within the CN calculates the location and transmits the location to the UE. By doing so, the UE may obtain the current location thereof.

On the other hand, referring to FIG. 15 (b), when remote UE and relay UEs are on different cells and when the remote UE performs LMF-based positioning, the remote UE may send a request for a posSIB to a serving gNB on-demand. In this case, the remote UE may also transmit information on the best RSRP gNB/TRP measured by the remote UE and the recommended reference gNB/TRP of the remote UE. Additionally/alternatively, the remote UE may also transmit information on a list of neighboring gNB IDs (and/or cell ID) where the remote UE is capable of receiving easily. Upon receiving the information, a CN may configure gNBs around the remote UE including the best RSRP gNB/TRP and recommended reference gNB/TRP as well as the list of neighboring gNB IDs/cell IDs where the remote UE is capable of receiving easily, to transmit the PRS. In this case, the gNBs configured by the CN or the configuration in the posSIB transmitted by the CN may be restricted to mandatorily include the information (e.g., gNB ID, cell ID) of the best RSRP gNB/TRP and recommended reference gNB/TRP that the remote UE reports. The information on the gNBs/TRPs transmitting the PRS may be transmitted to the remote UE in the posSIB. Upon receiving the posSIB, the remote UE measures the time difference (RSTD) between PRSs transmitted by neighboring gNBs based on the PRS configuration included in the posSIB and then transmits the time difference (RSTD) to the serving cell via the relay UE.

The remote UE may be restricted to include the time difference based on the information on the best RSRP gNB/TRP and recommended reference gNB/TRP measured/reported by the remote UE in measuring the time difference between PRSs. Compared to LMF-based positioning performed by the normal UE, the remote UE may not measure the PRS from its serving cell but may report measurement results to the serving cell.

Regarding the context described above, a remote UE in a wireless communication system may include: at least one processor; and at least one computer memory operably connected to the at least one processor and configured to store instructions that, when executed, cause the at least one processor to perform operations. The operations may include: establishing a connection with a relay UE; receiving information on a PRS transmitted by a plurality of BSs; receiving a plurality of PRSs from at least some BSs among the plurality of BSs; and measuring an RSTD for each pair of PRSs among the plurality of PRSs. The at least some BSs may necessarily include a BS with a best signal strength among BSs measured by the remote UE or a recommended BS of the remote UE.

In addition, there is provided a processor configured to perform operations for a remote UE in a wireless communication system. The operations may include: establishing a connection with a relay UE; receiving information on a PRS transmitted by a plurality of BSs; receiving a plurality of PRSs from at least some BSs among the plurality of BSs; and measuring an RSTD for each pair of PRSs among the plurality of PRSs. The at least some BSs may necessarily include a BS with a best signal strength among BSs measured by the remote UE or a recommended BS of the remote UE.

Further, there is provided a non-volatile computer-readable storage medium configured to store at least one computer program including instructions that, when executed by at least one processor, cause the at least one processor to perform operations for a remote UE. The operations may include: establishing a connection with a relay UE; receiving information on a PRS transmitted by a plurality of BSs; receiving a plurality of PRSs from at least some BSs among the plurality of BSs; and measuring an RSTD for each pair of PRSs among the plurality of PRSs. The at least some BSs may necessarily include a BS with a best signal strength among BSs measured by the remote UE or a recommended BS of the remote UE.

A PRS measurement method for reducing power consumption in a remote UE may be used/applied in combination with or independently of the above-described embodiments.

The remote UE is likely to be a UE that requires low power. Therefore, if the UE constantly measures RSRP on Uu, it may become a burden in terms of power consumption in the remote UE. To reduce the measurement burden (e.g., SSS, PBCH DMRS, etc.) of the remote UE, the following method is proposed.

For example, when the maximum value of DL PRS measurements (and/or the minimum value of top X %) is within a specified threshold range (and/or below a threshold level) (and/or when the maximum value is lower than a preconfigured offset compared to the most recent or current best RSRP measurement), the remote UE may be configured to perform the corresponding RSRP measurements.

The parameters related to the frequency/periodicity of RSRP measurements or event triggering status/probability for the RSRP measurements be configured differently depending on parameters related to changes in the location and movement speed of the remote UE.

Additionally, RSRP measurements to be compared with DL PRS measurements may be separate RSRP measurements triggered for positioning or RSRP measurement for switching between indirect and direct paths.

### Examples of Communication Systems Applicable to the Present Disclosure

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

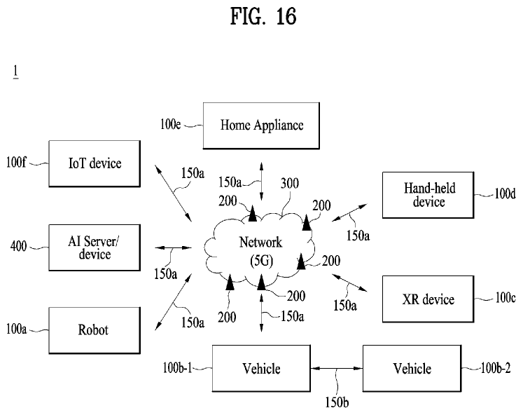

FIG. 16 illustrates a communication system 1 applied to the present disclosure.

Referring to FIG. 16, a communication system 1 applied to the present disclosure includes wireless devices, BSs, and a network. Herein, the wireless devices represent devices performing communication using RAT (e.g., 5G NR or LTE) and may be referred to as communication/radio/5G devices. The wireless devices may include, without being limited to, a robot 100a, vehicles 100b-1 and 100b-2, an extended reality (XR) device 100c, a hand-held device 100d, a home appliance 100e, an Internet of things (IoT) device 100f, and an artificial intelligence (AI) device/server 400. For example, the vehicles may include a vehicle having a wireless communication function, an autonomous driving vehicle, and a vehicle capable of performing communication between vehicles. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. V2V/V2X communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as UL/DL communication 150a, sidelink communication 150b (or, D2D communication), or inter BS communication (e.g. relay, integrated access backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

### Examples of Wireless Devices Applicable to the Present Disclosure

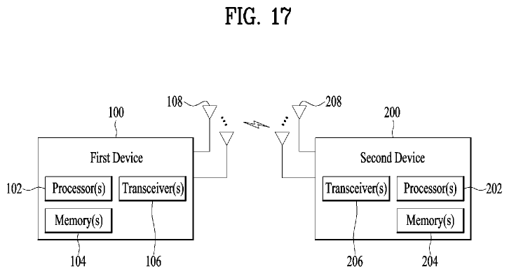

FIG. 17 illustrates wireless devices applicable to the present disclosure.

Referring to FIG. 17, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 16.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more service data unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

### Examples of a Vehicle or an Autonomous Driving Vehicle Applicable to the Present Disclosure

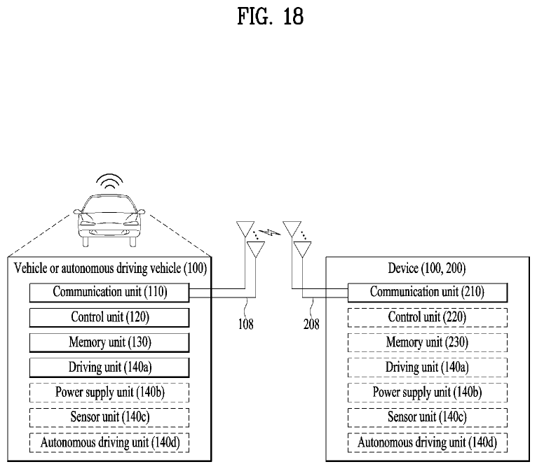

FIG. 18 illustrates a vehicle or an autonomous driving vehicle applied to the present disclosure. The vehicle or autonomous driving vehicle may be implemented by a mobile robot, a car, a train, a manned/unmanned aerial vehicle (AV), a ship, etc.

Referring to FIG. 18, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

### Examples of a Vehicle and AR/VR Applicable to the Present Disclosure

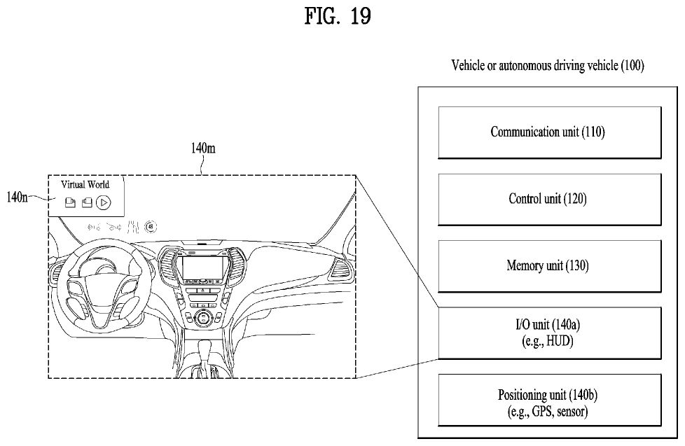

FIG. 19 illustrates a vehicle applied to the present disclosure. The vehicle may be implemented as a transport means, an aerial vehicle, a ship, etc.

Referring to FIG. 19, a vehicle 100 may include a communication unit 110, a control unit 120, a memory unit 130, an I/O unit 140a, and a positioning unit 140b.

The communication unit 110 may transmit and receive signals (e.g., data and control signals) to and from external devices such as other vehicles or BSs. The control unit 120 may perform various operations by controlling constituent elements of the vehicle 100. The memory unit 130 may store data/parameters/programs/code/commands for supporting various functions of the vehicle 100. The I/O unit 140a may output an AR/VR object based on information within the memory unit 130. The I/O unit 140a may include an HUD. The positioning unit 140b may acquire information about the position of the vehicle 100. The position information may include information about an absolute position of the vehicle 100, information about the position of the vehicle 100 within a traveling lane, acceleration information, and information about the position of the vehicle 100 from a neighboring vehicle. The positioning unit 140b may include a GPS and various sensors.

As an example, the communication unit 110 of the vehicle 100 may receive map information and traffic information from an external server and store the received information in the memory unit 130. The positioning unit 140b may obtain the vehicle position information through the GPS and various sensors and store the obtained information in the memory unit 130. The control unit 120 may generate a virtual object based on the map information, traffic information, and vehicle position information and the I/O unit 140a may display the generated virtual object in a window in the vehicle (1410 and 1420). The control unit 120 may determine whether the vehicle 100 normally drives within a traveling lane, based on the vehicle position information. If the vehicle 100 abnormally exits from the traveling lane, the control unit 120 may display a warning on the window in the vehicle through the I/O unit 140a. In addition, the control unit 120 may broadcast a warning message regarding driving abnormity to neighboring vehicles through the communication unit 110. According to situation, the control unit 120 may transmit the vehicle position information and the information about driving/vehicle abnormality to related organizations.

### Examples of an XR Device Applicable to the Present Disclosure

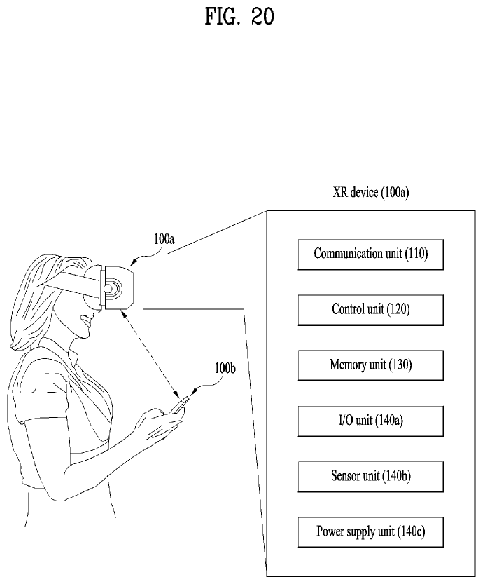

FIG. 20 illustrates an XR device applied to the present disclosure. The XR device may be implemented by an HMD, an HUD mounted in a vehicle, a television, a smartphone, a computer, a wearable device, a home appliance, a digital signage, a vehicle, a robot, etc.

Referring to FIG. 20, an XR device 100a may include a communication unit 110, a control unit 120, a memory unit 130, an I/O unit 140a, a sensor unit 140b, and a power supply unit 140c.

The communication unit 110 may transmit and receive signals (e.g., media data and control signals) to and from external devices such as other wireless devices, hand-held devices, or media servers. The media data may include video, images, and sound. The control unit 120 may perform various operations by controlling constituent elements of the XR device 100a. For example, the control unit 120 may be configured to control and/or perform procedures such as video/image acquisition, (video/image) encoding, and metadata generation and processing. The memory unit 130 may store data/parameters/programs/code/commands needed to drive the XR device 100a/generate XR object. The I/O unit 140a may obtain control information and data from the exterior and output the generated XR object. The I/O unit 140a may include a camera, a microphone, a user input unit, a display unit, a speaker, and/or a haptic module. The sensor unit 140b may obtain an XR device state, surrounding environment information, user information, etc. The sensor unit 140b may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone and/or a radar. The power supply unit 140c may supply power to the XR device 100a and include a wired/wireless charging circuit, a battery, etc.

For example, the memory unit 130 of the XR device 100a may include information (e.g., data) needed to generate the XR object (e.g., an AR/VR/MR object). The I/O unit 140a may receive a command for manipulating the XR device 100a from a user and the control unit 120 may drive the XR device 100a according to a driving command of a user. For example, when a user desires to watch a film or news through the XR device 100a, the control unit 120 transmits content request information to another device (e.g., a hand-held device 100b) or a media server through the communication unit 130. The communication unit 130 may download/stream content such as films or news from another device (e.g., the hand-held device 100b) or the media server to the memory unit 130. The control unit 120 may control and/or perform procedures such as video/image acquisition, (video/image) encoding, and metadata generation/processing with respect to the content and generate/output the XR object based on information about a surrounding space or a real object obtained through the I/O unit 140a/sensor unit 140b.

The XR device 100a may be wirelessly connected to the hand-held device 100b through the communication unit 110 and the operation of the XR device 100a may be controlled by the hand-held device 100b. For example, the hand-held device 100b may operate as a controller of the XR device 100a. To this end, the XR device 100a may obtain information about a 3D position of the hand-held device 100b and generate and output an XR object corresponding to the hand-held device 100b.

### Examples of a Robot Applicable to the Present Disclosure

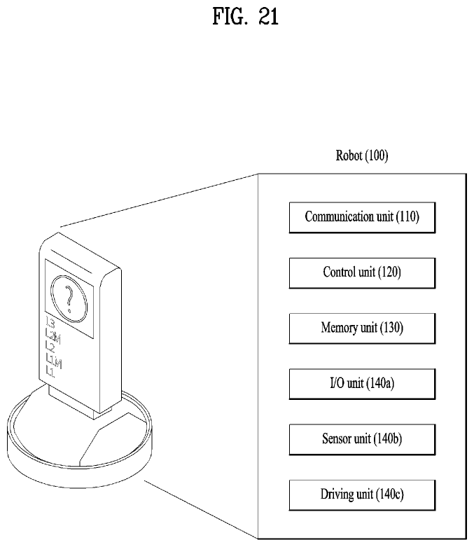

FIG. 21 illustrates a robot applied to the present disclosure. The robot may be categorized into an industrial robot, a medical robot, a household robot, a military robot, etc., according to a used purpose or field.

Referring to FIG. 21, a robot 100 may include a communication unit 110, a control unit 120, a memory unit 130, an I/O unit 140a, a sensor unit 140b, and a driving unit 140c. Herein, the blocks 110 to 130/140a to 140c correspond to the blocks 110 to 130/140 of FIG. 17, respectively.

The communication unit 110 may transmit and receive signals (e.g., driving information and control signals) to and from external devices such as other wireless devices, other robots, or control servers. The control unit 120 may perform various operations by controlling constituent elements of the robot 100. The memory unit 130 may store data/parameters/programs/code/commands for supporting various functions of the robot 100. The I/O unit 140a may obtain information from the exterior of the robot 100 and output information to the exterior of the robot 100. The I/O unit 140a may include a camera, a microphone, a user input unit, a display unit, a speaker, and/or a haptic module. The sensor unit 140b may obtain internal information of the robot 100, surrounding environment information, user information, etc. The sensor unit 140b may include a proximity sensor, an illumination sensor, an acceleration sensor, a magnetic sensor, a gyro sensor, an inertial sensor, an IR sensor, a fingerprint recognition sensor, an ultrasonic sensor, a light sensor, a microphone, a radar, etc. The driving unit 140c may perform various physical operations such as movement of robot joints. In addition, the driving unit 140c may cause the robot 100 to travel on the road or to fly. The driving unit 140c may include an actuator, a motor, a wheel, a brake, a propeller, etc.

### Example of AI Device to which the Present Disclosure is Applied

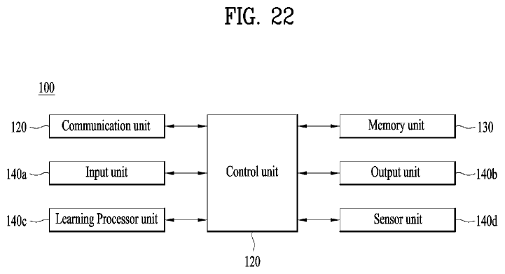

FIG. 22 illustrates an AI device applied to the present disclosure. The AI device may be implemented by a fixed device or a mobile device, such as a TV, a projector, a smartphone, a PC, a notebook, a digital broadcast terminal, a tablet PC, a wearable device, a Set Top Box (STB), a radio, a washing machine, a refrigerator, a digital signage, a robot, a vehicle, etc.

Referring to FIG. 22, an AI device 100 may include a communication unit 110, a control unit 120, a memory unit 130, an I/O unit 140a/140b, a learning processor unit 140c, and a sensor unit 140d. The blocks 110 to 130/140a to 140d correspond to blocks 110 to 130/140 of FIG. 17, respectively.

The communication unit 110 may transmit and receive wired/radio signals (e.g., sensor information, user input, learning models, or control signals) to and from external devices such as other AI devices (e.g., 100x, 200, or 400 of FIG. 16) or an AI server (e.g., 400 of FIG. 16) using wired/wireless communication technology. To this end, the communication unit 110 may transmit information within the memory unit 130 to an external device and transmit a signal received from the external device to the memory unit 130.

The control unit 120 may determine at least one feasible operation of the AI device 100, based on information which is determined or generated using a data analysis algorithm or a machine learning algorithm. The control unit 120 may perform an operation determined by controlling constituent elements of the AI device 100. For example, the control unit 120 may request, search, receive, or use data of the learning processor unit 140c or the memory unit 130 and control the constituent elements of the AI device 100 to perform a predicted operation or an operation determined to be preferred among at least one feasible operation. The control unit 120 may collect history information including the operation contents of the AI device 100 and operation feedback by a user and store the collected information in the memory unit 130 or the learning processor unit 140c or transmit the collected information to an external device such as an AI server (400 of FIG. 16). The collected history information may be used to update a learning model.

The memory unit 130 may store data for supporting various functions of the AI device 100. For example, the memory unit 130 may store data obtained from the input unit 140a, data obtained from the communication unit 110, output data of the learning processor unit 140c, and data obtained from the sensor unit 140. The memory unit 130 may store control information and/or software code needed to operate/drive the control unit 120.

The input unit 140a may acquire various types of data from the exterior of the AI device 100. For example, the input unit 140a may acquire learning data for model learning, and input data to which the learning model is to be applied. The input unit 140a may include a camera, a microphone, and/or a user input unit. The output unit 140b may generate output related to a visual, auditory, or tactile sense. The output unit 140b may include a display unit, a speaker, and/or a haptic module. The sensing unit 140 may obtain at least one of internal information of the AI device 100, surrounding environment information of the AI device 100, and user information, using various sensors. The sensor unit 140 may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone, and/or a radar.

The learning processor unit 140c may learn a model consisting of artificial neural networks, using learning data. The learning processor unit 140c may perform AI processing together with the learning processor unit of the AI server (400 of FIG. 16). The learning processor unit 140c may process information received from an external device through the communication unit 110 and/or information stored in the memory unit 130. In addition, an output value of the learning processor unit 140c may be transmitted to the external device through the communication unit 110 and may be stored in the memory unit 130.

### INDUSTRIAL APPLICABILITY

The above-described embodiments of the present disclosure are applicable to various mobile communication systems.

1. A method of operating a remote user equipment (UE) in a wireless communication system, the method comprising:
receiving, by the remote UE, information on a positioning reference signal (PRS) transmitted by a plurality of base stations (BSs);
receiving, by the remote UE, a plurality of PRSs from at least some BSs among the plurality of BSs; and
measuring, by the remote UE, a reference signal time difference (RSTD) for each pair of PRSs among the plurality of PRSs,
wherein the at least some BSs necessarily includes a BS with a best signal strength among BSs measured by the remote UE or a recommended BS of the remote UE.

2. The method of claim 1, wherein the remote UE transmits information on the BS with the best signal strength or the recommended BS of the remote UE to a serving BS.

3. The method of claim 1, wherein in determining a location, the remote UE necessarily uses a PRS from the BS with the best signal strength or a PRS from the recommended BS of the remote UE, wherein the BSs are reported by the remote UE.

4. The method of claim 1, wherein in determining a location, the remote UE skips performing measurements on a serving cell.

5. The method of claim 1, wherein the remote UE determines a location of the remote UE based on measurement results.

6. The method of claim 1, wherein the remote UE transmits measurement results to a serving cell and receives information on a location of the remote UE determined by a location management function (LMF) based on the measurement results.

7. The method of claim 2, wherein the information on the BS with the best signal strength or the recommended BS of the remote UE is included in an on-demand system information block (SIB) request transmitted by the remote UE to a serving BS through a relay UE.

8. The method of claim 1, wherein the information on the PRS transmitted by the plurality of BSs is included in a positioning SIB (proSIB).

9. The method of claim 8, wherein the proSIB includes a PRS configuration related to the plurality of BSs.

10. The method of claim 8, wherein the proSIB is transmitted by a serving BS of a relay UE.

11. The method of claim 1, wherein a serving BS of a relay UE is identical to a serving BS of the remote UE.

12. A remote user equipment (UE) in a wireless communication system, the remote UE comprising:
at least one processor; and
at least one computer memory operably connected to the at least one processor and configured to store instructions that, when executed, cause the at least one processor to perform operations comprising:
receiving information on a positioning reference signal (PRS) transmitted by a plurality of base stations (BSs);
receiving a plurality of PRSs from at least some BSs among the plurality of BSs; and
measuring a reference signal time difference (RSTD) for each pair of PRSs among the plurality of PRSs,
wherein the at least some BSs necessarily includes a BS with a best signal strength among BSs measured by the remote UE or a recommended BS of the remote UE.

13. The remote UE of claim 12, wherein the remote UE communicates with at least one of another UE, a UE related to an autonomous vehicle, a BS, or a network.

14. A processor configured to perform operations for a remote user equipment (UE) in a wireless communication system, the operations comprising:
receiving information on a positioning reference signal (PRS) transmitted by a plurality of base stations (BSs);
receiving a plurality of PRSs from at least some BSs among the plurality of BSs; and
measuring a reference signal time difference (RSTD) for each pair of PRSs among the plurality of PRSs,
wherein the at least some BSs necessarily includes a BS with a best signal strength among BSs measured by the remote UE or a recommended BS of the remote UE.

15. A non-volatile computer-readable storage medium configured to store at least one computer program comprising instructions that, when executed by at least one processor, cause the at least one processor to perform operations for a remote user equipment (UE), the operations comprising:
receiving information on a positioning reference signal (PRS) transmitted by a plurality of base stations (BSs);
receiving a plurality of PRSs from at least some BSs among the plurality of BSs; and
measuring a reference signal time difference (RSTD) for each pair of PRSs among the plurality of PRSs,
wherein the at least some BSs necessarily includes a BS with a best signal strength among BSs measured by the remote UE or a recommended BS of the remote UE.
